(19) United States
(12) Patent Application Publication
(10) Pub. No.: US 2026/0370647 A1
(43) Pub. Date: Nov. 19, 2026

(54) PERMISSION-BASED ACCESS CONTROL AND RESOURCE ALLOCATION FOR QUANTUM-COMPUTING UTILITIES

(71) Applicant: 8ORCAS, Inc., Dover, DE (US)

(72) Inventors: Anna E. Shebanow, Dover, DE (US); Jack Wolosewicz, San Francisco, CA (US)

(73) Assignee: 8ORCAS, Inc., Dover, DE (US)

(21) Appl. No.: 19/749,797

(22) Filed: Jul. 22, 2026

Related U.S. Application Data
(63) Continuation-in-part of application No. 19/321,934, filed on Sep. 8, 2025.
(60) Provisional application No. 63/698,371, filed on Sep. 24, 2024.

(51) Int. Cl. H04L 9/40; G06N 10/20; H04L 9/00; H04L 9/32

(52) U.S. Cl. CPC H04L 63/10; G06N 10/20; H04L 9/3247; H04L 9/50; H04L 63/0428

(57) ABSTRACT

A method, system, and non-transitory computer-readable medium control access to networked quantum-computing resources. A requesting entity submits a request to access a quantum-computing utility with an API key. An identity token bearing a cryptographic digital signature is generated and verified to establish a validated identity. Each resource, drawn from a plurality associated with a provider entity having direct control over its collection, is restricted to a single controlling entity at a time, and a recorded database is queried for the current recordation before access is granted at an access-control gate. A package validate process confirms this recordation at request time, while an internal blockchain module appends each granted permission as a cryptographically linked block for resolving the current recordation. An interchangeable quantum-computing utility matching the request is allocated on demand, substituting a specific utility for a generic one, over a private tunnel encrypted at both ends.

### FIELD OF THE TECHNOLOGY DISCLOSED

The present technology disclosed pertains generally to methods for transactions on quantum computing Utilities, including more particularly to methods for purchasing quantum computing resource packages in a networked exchange marketplace for the purpose of providing access to quantum computing offered by many quantum computing utilities service providers, to address cybersecurity vulnerabilities posed by quantum computing advancements, improved utilities allocation, improved utilization, more choices for consumers of such utilities, and the establishment of fair market values for quantum computing utilities.

The present technology disclosed further pertains to securing such transactions against adversaries equipped with cryptographically relevant quantum computers by means of a post-quantum cryptographic key lifecycle management architecture, and to assisting entities in searching for, matching, and simulating solutions using such quantum computing utilities packages by means of artificial intelligence and machine learning systems.

### BACKGROUND OF THE TECHNOLOGY DISCLOSED

One of the most challenging issues related to quantum computing is the cost. Most organizations will not be able to have in-house quantum computing for their operations. Another challenging task for consumers of quantum computing is the accessibility to utilities from many service providers. Another challenge related to quantum computing is that service providers are not able accurately forecast usage and required utilities, factors that raise the cost of quantum computing operations for service providers organizations. In a dynamic and inter-organizational setting, the scheduling and pricing of quantum utilities are key challenges, that is deciding which user can access what utility at what time at what price cost, and for what purpose. Sudden surges in demand and underutilization of utilities cause quantum computing service providers to lose revenue creating the need for a more efficient market model. Market mechanisms show promise for enhancing quantum computing utilities allocation and pricing in quantum computing. The shortcomings associated with the supply-and-demand of quantum computing utilities have heretofore not been adequately addressed. The present technology disclosed addresses such problems by providing a novel system and processing approach, and to address the businesses needs addressing the protection of assets and use to solve business and scientific problems in speedy manner.

Market-based mechanisms for allocating computing resources are known in the art. For example, Amazon Web Services introduced a Spot Instance marketplace in 2009 in which excess classical cloud computing capacity is offered to consumers at variable, market-determined prices for defined time windows, with automatic reclamation of resources upon expiry or when the prevailing market price exceeds the consumer's maximum bid. This demonstrates that the concept of a time-window-constrained, market-based exchange for computing resources is not abstract but rather a well-established, concrete, and commercially proven model in the classical computing domain. However, such existing systems are designed exclusively for classical computing resources and do not address the distinct technical challenges of quantum computing utilities, including: the physical scarcity and non-fungibility of quantum hardware components such as quantum processors, qubits, and associated control electronics; the requirement for cryptographic verification of resource access rights across multiple independent providers and consumers operating in a distributed environment without a single controlling authority; the cybersecurity vulnerabilities posed by quantum computing advancements against classical cryptographic methods used to secure marketplace transactions; or the need for post-quantum cryptographic key lifecycle management to protect marketplace integrity against adversaries equipped with cryptographically relevant quantum computers. The present technology disclosed addresses these unsolved problems by extending and specializing the proven market-exchange model specifically to quantum computing utilities, with the additional concrete technical mechanisms of blockchain-gated access verification, uniquely-constrained single-entity package right of use enforced at the system level via the Recorded Database, and a post-quantum cryptographic key lifecycle management architecture secured by ML-DSA and SLH-DSA on a quantum-resistant distributed ledger, none of which are present in or suggested by classical cloud computing spot markets.

### SUMMARY OF THE TECHNOLOGY DISCLOSED

An object of this technology disclosed is to provide a new method for optimizing quantum computing utilities allocation, utilization, and provisioning with competition for both sides, buyers and sellers, using a computer network to gain access to quantum computing utilities packages in an exchange marketplace environment by means of different contract types such as “buy now-pay now-use now”, “buy now-pay now-use later”, “buy now-pay later-use later”, or swap what has been bought for other utilities, and/or other means of contracts.

It is a further object of this technology disclosed to represent quantum computing utilities as a form of technology property and traded as such. That is, by structuring quantum computing utilities into packages by service providers that specify a range of time availability and potentially other constraints, we create an exchange marketplace where customers can conduct transaction on quantum packages placed by quantum service providers on the exchange marketplace. Since utilities are now tradable, we can let market forces determine the proper price point for these utilities and better match supply to demand. We define a package at minimum as a description of utilities and time window for which such utilities might be used, and we define the ability for a consumer to use these utilities at the specified time window package right of use. Package right of use is in a sense ownership of a package.

Another object of this technology disclosed is the concept that such packages can be made generic and interchangeable. In this technology disclosed, we call generic forms of packages Quantum Utility Exchange Traded Resources (QU-ETRs). QU-ETRs are in effect templates for packages. The QU-ETR concept enables service providers to generically define a class of utility packages making them interchangeable to an end user.

Another object of this technology disclosed is the definition of a Quantum Utility Exchange (QUE), a networked market in which packages and QU-ETRs can be in transactions much like other forms of items that can be purchased or sold. Bids to either buy or sell quantum utilities packages and/or QU-ETRs can be placed, more complex forms of transactions are also possible.

A further object of this technology disclosed derives from another the implementation of the embodiment. In the embodiment, software designed to execute the functionality of a marketplace is executed by at least one of the one or more processing units on a server computer system to allow users to participate in the marketplace by using an application programming interface (API) key.

Another object of this technology disclosed is to have a pair of data bases which are employed to record pending buy/sell bids and to record completed sales. Since this information contains a record of past and present market activity for packages and QU-ETRs, savvy providers, consumers suitably connected to the information contained in the databases can employ data mining to predict future demand, future pricing trends, or any other statistic desired. By having such information at their disposal, users and organizations transacting actively in quantum computing utilities can better predict demand and better optimize their use and offering of quantum computing utilities.

Another object of this technology disclosed is to use the blockchain technology to store, manage, and retrieve permissions, and access for information. The blockchain implementation employs a security attribute model, such as Oracle® Label Security, to record and enforce access permissions for data. Blockchain technology enhances transaction security and increases transparency between quantum service providers and consumers. When either party requests access, the blockchain verifies permissions and identities, enabling security information retrieval. The blockchain provides traceability and blocks access from unwanted and unidentified entities which helps quantum service providers to be in control of entities using their quantum utilities. Quantum service providers can use prompt to identify the entities who have used their quantum utilities and offer other utilities or block them from using their future utilities. All the data activities from both sides the service providers and consumers will be a part of blockchain.

Another object of this technology disclosed is to secure the blockchain-based permissioning described above, and all other cryptographic operations of the QUE system, against adversaries equipped with cryptographically relevant quantum computers. This technology disclosed accomplishes this object by means of a post-quantum cryptographic key lifecycle management system employing NIST-standardized ML-DSA and SLH-DSA digital signature algorithms on a dedicated quantum-resistant distributed ledger, as described in greater detail below.

A further object of this technology disclosed is to provide a specific technical solution to the technical problem of over-allocation and unauthorized concurrent access of scarce quantum hardware resources across a multi-provider, multi-consumer distributed computing environment. The claimed architecture solves this technology problem through three concrete technical mechanisms: (a) enforcing, at the system level via the Recorded Database, a uniquely-constrained single-entity package right of use that prevents more than one entity from controlling any defined quantum computing resource during any specified time window; (b) automatically delisting packages or QU-ETRs from the Recorded Database upon expiry of said time window or upon reaching a defined utility limit, thereby freeing said resources for re-allocation; and (c) gating all quantum workload execution through an internal blockchain module that cryptographically verifies, prior to permitting access, that the requesting entity currently holds valid package right of use for the specific resources being requested. These technical mechanisms operate at the computer-system level, cannot be performed in the human mind or on paper, and collectively constitute an improvement to distributed computing resource management technology.

A further object of this technology disclosed derives from another the implementation of the embodiment. In the embodiment, the communication between buyers and sellers is established and conducted through instructions on the computing system based on identity tokens, then the identify tokens are communicated to the security software module to determine if the API key is a valid key. The computer system generates the identity tokens through a cryptographic token generation script when the API key to be valid by the system. API key is uniquely associated with a single organization or a user or a buyer or seller and establishes an association between the identity token and the organization/user/buyer or seller. The transmitted information between parties is encrypted. Encrypted information is sent and received and is signed with a cryptographic digital signature and identity tokens. The receiving comprises decrypting the information using the identity tokens to form decrypted information and validation of signature. The identify tokens related activities are stored in a database. Other techniques of security mechanism can also be implemented for faster and better identity tokens. Buyers of quantum utilities can invoke AI prompt action to request package type and its information, and request information, or ask to provide any quantum machine learning approach to get the best solution for a problem, or simulate a problem using quantum machine learning or other techniques, or search for a particular information using quantum machine learning techniques, also can be based on package configuration types, cost, date, and more.

### BRIEF DESCRIPTION OF THE DRAWINGS

In the following description, numerous specific details are set forth to provide a more thorough understanding of the present technology disclosed. However, it will be apparent to one skilled in the art that the present technology disclosed may be practiced without one or more of these specific details. In other instances, well-known features have not been described in order to avoid obscuring the present technology disclosed. The technologies disclosed and described herein in terms for quantum utilities exchange marketplace server utilizing the Internet and the World Wide Web. However, after reading this description, it will be apparent how to implement the technology disclosed in alternative embodiments and alternative network environments. For example, alternative network environments include any large-scale wide area network and its accompanying networking protocols which may encompass one or more functions now provided by today's Internet, cable and broadcast television, telephone communications and other linear and interactive business and telecommunications systems. As such, the description of this example embodiment should not be construed to limit the scope and breadth of the technologies disclosed as claimed herein.

FIG. 1 is an example of an electronic Quantum Utilities Exchange (QUE) implementation.

FIG. 2 is a schematic illustration of a post-quantum cryptographic key lifecycle management system.

FIG. 3 is a flow diagram of a process for controlling access to a quantum computing utility.

FIG. 4 is a block diagram of an access control gate.

FIG. 5 is a flow diagram of an identity validation process.

FIG. 6 is a state diagram illustrating recordation and transfer of a package right of use.

FIG. 7 is a flow diagram of an on demand allocation process.

FIG. 8 is a schematic diagram of a private tunnel conducting communications between a requesting entity and a provider.

FIG. 9 is a schematic representation of an encoder-decoder architecture.

FIG. 10 shows an overview of an attention mechanism added onto an RNN encoder-decoder architecture.

FIG. 11 is a schematic representation of the calculation of self-attention showing one attention head.

FIG. 12 is a depiction of several attention heads in a Transformer block.

FIG. 13 is an illustration that shows how one can use multiple workers to compute the multi-head attention in parallel, as the respective heads compute their outputs independently of one another.

FIG. 14 is a portrayal of one encoder layer of a Transformer network.

FIG. 15 shows a schematic overview of a Transformer model.

FIG. 16 is a depiction of a Vision Transformer (ViT).

FIG. 17 illustrates a processing flow of the Vision Transformer (ViT).

FIG. 18 shows example software code that implements a Transformer block.

FIG. 19 shows an example computer system that can be used to implement the technology disclosed.

### DETAILED DESCRIPTION

An organization is a group of two or more people and/or other organizations or subsets thereof grouped together for some purpose. Examples of organizations include but are not limited to corporations, partnerships, and trusts. Organizations can band together with other organizations, parts of organizations, or individuals to form new organizations. In order to simplify future discussions regarding individuals or organizations, we define an entity as either a single person or an organization.

A utility is either some tangible equipment or property owned or otherwise controlled by an entity or an intangible capability that can be applied or otherwise controlled by some entity. Examples of tangible utility apropos to this technology disclosed include but are not limited to quantum technology, computer equipment, storage equipment, communication equipment, any aspect of quantum technology, software, and I/O devices such as printers or terminals. Examples of intangible resources include but are not limited to consulting services, warranties, customer support, and quantum as well as IT administrative support.

In the context of this technology disclosed, there are several types of entities. First, provider entities are those entities that own and/or manage one or more quantum utilities and make these utilities available for use by other entities. Henceforth, they will simply be referred to as providers. Examples of providers include but are not limited to corporations that own and maintain a quantum computer cluster and make that quantum cluster available or use by outside organizations or individuals. Consumer entities are those entities that utilize one or more utilities for some application of their own choosing. Henceforth, they will simply be referred to as consumers.

A time window is a specific range of dates and times inclusive of and commencing with a start date and start time and inclusive of and terminating at an end date and end time. To avoid ambiguity in the specification of start and end times, these times might be specified in coordinated universal time (UTC). Utilities-time is the cumulative application of a quantum resource for a given amount of time, time being measured as a difference in UTC. For example, if a computer executes a computer program for 1 hour and at some later and non-contiguous time runs another program two hours, the utility-time for that computer is said to be 3 program-execution-hours. The definition of utility-time is always measured in the application of a utility and resource type for some cumulative period.

A utility limit is some constraint on the use of a utility. An example of a utility limit is a constraint on the total utility-time a utility may be used by some entity. Another example could be on the total consumption of some utilities. For example, a network utility limit might constrain an entity from transferring data across a communications network. In general, a utility limit is a quantified constraint on some metric defined for the utility, a metric being a measurement of capacity associated with that utility.

An entity that directs the application or usage of a utility is said to control that utility. Control in this case does not mean ownership. Instead, control is meant to infer the ability to direct how a utility is applied or in fact who can employ a utility. One entity can release control of a utility to another for all time or some specified time window. Barring unforeseen circumstances (for example system outages, network interruptions, etc.), when released, the entity releasing control loses control for the time specified (or potentially permanently). An entity can also have direct control over a utility. In this case, direct control means that the entity has physical control and/or responsibility for a utility. For example, if a provider has built a data center containing many quantum computers, utilities, disk storage systems, and network infrastructure to interconnect them, that provider has direct control over those utilities. Control is an intangible property while direct control is physical.

In the context of this technology disclosed, at minimum, a package must specify a collection of one or more utilities and a time window over which the package utilities may be controlled. Optionally, a package might also specify a transfer expiration time, a time after which control of the package can no longer be transferred from one entity to another, and an optional set of one or more utility limits associated with the utility of the package.

The above list of items is not intended to constrain the definition or contents of a package. Entities defining packages can add additional definitions to a package as required, in essence allowing a package to be customized as required. However, packages must be defined such that an entity is in control of all the utilities specified in the package for the time window specified, either because the entity directly manages and/or owns a utility or because the entity acquired control of the utility from some other entity or entities that had control. For example, in defining a new package, an entity could disassemble the contents of another set of packages and assign subsets of their utility to the new package so long as it has control of those utility for the time window specified in the new package. In other words, the definitions of a package are flexible and could in fact be defined in terms of the contents of other packages.

A package is always controlled by an entity and such control is termed package right of use. Package right of use implies the right to control and if desired use any or all of the utilities defined in the package during the time window specified up to any of the limits specified by the package. Note that controlling a package and using the packages utilities during the specified time window are not the same thing. An entity could control a package but never use any of its utilities for example. At the end of the time window for a package, package right of use expires and the package becomes undefined. When a package is defined, the entity defining the package has initial package right of use. Any utilities contained in the package can no longer be assigned or controlled by any other entity for its specified time window. This restriction guarantees that a utility will not be over-allocated or used by more than one entity during that time window.

For purposes of this disclosure, “package right of use” is a defined technical and legal construct distinct from ownership. Package right of use confers upon the holding entity the exclusive right to direct, control, and consume the quantum computing utilities specified in the package during the time window specified, up to any defined utility limits, to the exclusion of all other entities. Package right of use is a system-enforced construct recorded in the Recorded Database and is not merely a contractual or administrative designation: it is a machine-enforced access control state that the QUE system actively maintains, verifies, and updates in real time. The Recorded Database enforces this state by ensuring that no more than one entity holds package right of use for any defined quantum computing resource during any specified time window, and the blockchain module independently verifies the current package right of use holder prior to permitting any quantum workload execution against the resources specified in the package.

Package right of use can be transferred from one entity to another. Such transfer is by agreement of both parties and may be consummated for any number of reasons, but typically is done when a controlling entity sells its package right of use in return for monetary compensation, said transfer being terms a package sale. A package sale is a contract between a seller, the entity having package right of use, and a buyer, an entity that wishes to gain package right of use from the seller. The contract in this case stipulates that seller conveys package right of use to the buyer in exchange for monetary compensation from buyer to seller. After conveyance, a seller releases all further control of the package utilities for the time window specified in the package.

A canonical package is a package of standard form. For example, a package might define access to the following resources: access to quantum computing comprising a superconductive circuit computer, quantum processors/quantum chip, classical computers, quantum firmware/software, quantum algorithms, qubits of any form, microwave electronics, and quantum operating system; and access to a network communications network. In addition, a single utility limit might also apply, namely a limit for transfer between the systems.

If many quantum service providers (or potentially consumers) define QU-ETRs packages of exactly this description, this package is a canonical template for other supplying entities to follow. If many consumers desire packages of this form, a canonical package is advantageous to both package suppliers and consumers: suppliers will find a large, generic market for their packages and consumers will find a ready supply of these packages. The canonical package concept is akin to that found in object-oriented programming languages such as C++: a class is a template for object instances of that class.

The definition of canonical packages enables the concept of a type of package termed the Quantum Utility Exchange traded resources (QU-ETR), packages defined in bulk and defined by many entities all following a single, canonical package template. Such packages are to a degree interchangeable. As mentioned before, availability of a large number of QU-ETRs (equivalently, packages of canonical form) provides a great deal of choice for consumers wishing to employ such packages.

QU-ETRs are in a sense packaged networked components in quantum technology and thus the sale of such packaged networked components from one entity to another is performed in an exchange marketplace specific to QU-ETRs. Note that the term packaged networked components in a marketplace denotes an overall transaction in one networked component and does not refer to a physical market. QU-ETRs are subject to price fluctuations mainly related to supply and demand.

In general, a networked exchange marketplace furnishes an electronic marketplace for the purpose of QU-ETRs transaction based on different contract types. The QUE is governed by some entity managing it and quite possibly by governmental organizations above them. We can define a specific form of networked exchange marketplace in this technology disclosed with the term a Quantum Utility Exchange (QUE) used to exchange quantum utilities packages between entities: a QUE is an exchange managed by some entity for the purpose of buying and selling quantum utilities packages and/or QU-ETRs. For the purposes of this technology disclosed, there are no restrictions on what entity can establish and manage a QUE. For example, a QUE can be established and maintained by an entity that is also a provider of all packages in the exchange. Or as another example, a separate entity might establish a QUE and encourage many other entities to participate in the exchange. The only requirement is that it must be for transactions of quantum utilities packages and/or QU-ETRs, the core quantum package types.

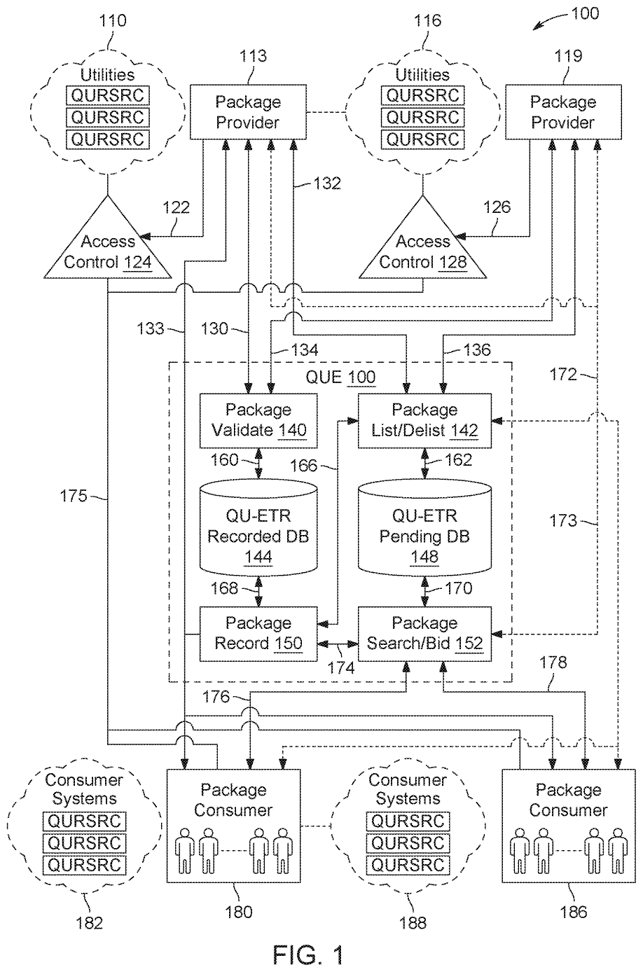

An example of an electronic Quantum Utilities Exchange (QUE) implementation is shown in FIG. 1. In the figure, there is a single QUE system 100. We envision that this system is a collection of hardware (computers, disks, network communication gear, etc.) running software implementing QUE. This system might have as little as a single computer running the entire exchange or may be in fact a large network of computers, all interconnected with a local intranet. Alternatively, there may be in fact multiple QUEs located in geographically diverse locations all interconnected through the Internet or other forms of communication. Such QUEs could share in the workload of running QU-ETR/package exchanges. Alternatively, a QUE could be implemented as part of one or more of the clouds shown in the Figure, Provider Cloud 110, 116, 182, and 188. In such a scenario, one or more providers host the QUE as part of their infrastructure in either a non-distributed or distributed manner. The depiction in FIG. 1 or in this description is not intended to limit the scope or structure of a QUE implementation and only serves as an example of how a QUE could be constructed and in fact employed. One skilled in the art could envision many different means of implementing a QUE or QUEs.

Continuing, in FIG. 1, there are one or more quantum utilities package provider entities 113 and 119. The figure only shows two such providers, but there might in fact be as few as a single provider or an arbitrary number of providers. Each quantum provider has associated with it a Provider Cloud (110 and 116 in the figure). Each quantum provider contains one or more quantum utilities resources (QURSRC) that the provider is willing to include as part of a package description. The type and structure of each quantum utility is up to the individual providers discretion and in fact can change from time to time as that provider so chooses. Throughout the following description, we will frequently refer to a provider as contacting a process or otherwise performing some action. In general, when stated as such, this means that the provider or an individual in the providers organization executing on its behalf performs some operation via a connection to an electronic infrastructure, that being either its own cloud (110 or 116 or example) or via some other computer terminal or other input/output device connected to the infrastructure shown in FIG. 1.

Likewise, there are also one or more consumer entities 180 and 186. As with providers, the figure depicts two such consumers, but in fact be as few as a single consumer or an arbitrary number of consumers. Each quantum consumer has associated with it a Consumer Cloud (182 and 188 in the figure). Each quantum consumer also has one more utility resource, the type and structure of each quantum utility being determined by each consumer and may vary from time to time. The purpose of each quantum utility is also up to the consumer. Typically though, the quantum utilities will be those quantum utilities that quantum providers offering. As with providers, throughout the following description, we will frequently refer to a consumer as contacting a process or otherwise performing some action. In general, when stated as such, this means that the consumer or an individual in the consumers organization executing on its behalf performs some operation via a connection to an electronic infrastructure, that being either its own cloud (182 or 188 or example) or via some other computer terminal or other input/output device connected to the infrastructure shown in FIG. 1.

As mentioned before, the figure depicts a single QUE 100. In the embodiment described herein, QUE 100 is a combination of software systems running on a dedicated computer network, the exact structure of which and its construction is not relevant to this technology disclosed and is not described. Instead, conceptually, QUE 100 is a set of two databases and four major functional actions. The remainder of this description will focus on the concept and not on the exact construction of the software and hardware necessary to implement this concept, as for one skilled in the art, such construction should be straight forward.

At minimum, the QU-ETR Pending DB 148 (DB is short for database) maintains a record of all quantum utilities packages available for sale or unfulfilled bids to purchase packages thereof. Henceforth, the QU-ETR Pending DB will simply be referred to as the pending DB. Each record in the pending DB must at minimum record which entity caused the record to come into existence, what type of record it is (offer to buy, offer to sell, etc.), what package is being offered/sought, constraints on the package price and contract types. More complex QUEs might in fact record much more information. Such additional exchange services would demand a more complex pending DB record format.

To help clarify the types of sale scenarios a QUE might need support; a few examples are provided. First, suppose a quantum provider 113 wishes to offer a quantum package for sale at a given price. That quantum provider operates software running on their cloud 110 or perhaps some other cloud, said software designed to allow a provider to define a quantum package: resources, time window, resource limits, etc. The quantum provider then contacts a Package List/Delist process 142 running on the QUE implementation via some means Comm Path 132 (Internet, Intranet, etc.) and communicates the package description to the QUE along with a list of terms of sale. For example, the provider might specify a limit price: sell the package for no less than $10. Alternatively, the sale could be at fixed price sell this package for exactly $10. Alternatively assuming the QUE supports this, the sale terms could be quite complex. For example, sell this quantum package for no less than $20 unless the package is unsold after 12 am on the date (Dec. 10, 2024) at which time sell the package at market price. Any number of market sale terms could be specified. Continuing, once the Package List/Delist process receives a directive to sell a quantum package, it records this in a record in the pending DB 148 via a communication path 162 unless a matching purchase offer is found before this. Furthermore, although not shown in FIG. 1, when the Package List/Delist process creates a new package sell offering in the pending DB 148, it might also cause the Package Record process 150 via communication path 166 to record the existence of the package in QU-ETR Recorded DB 144; such recordation is optional. Recordation of packages in this DB will be discussed further below.

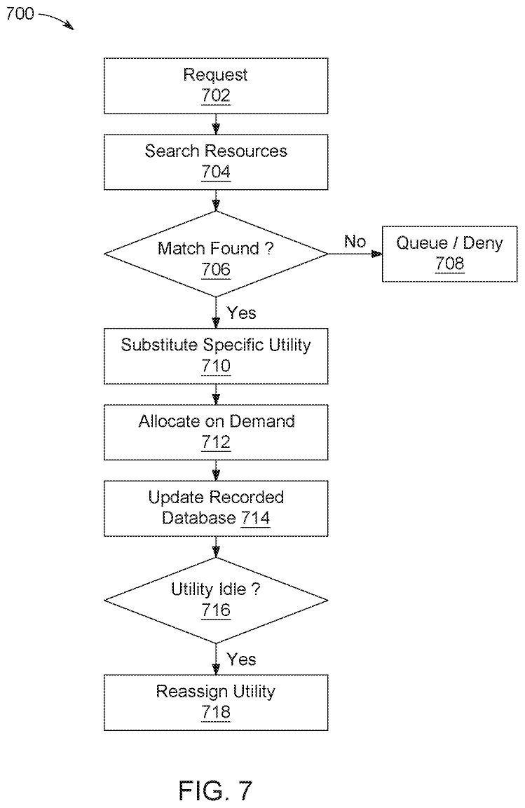

Another sales scenario might allow a provider to place for sale a large number of QU-ETRs. Recall that a QU-ETR is simply a form of quantum package, the packages being completely interchangeable. For example, assume provider 119 has a collection of 1000 identical quantum utilities available 116 and that these quantum utilities will be idle/not used on Dec. 11, 2024, unless the quantum provider can sell packages before then. Provider 119 constructs a QU-ETR for these servers using a mechanism similar to the process provider 113 used above to construct a package for a single server. In this case, provider 119 specifies the date and duration (24-hour period in this case), but leaves the quantum utilities resource specification as generic or some other means as required. Provider 119 does not actually care at the time the QU-ETR is created what server will eventually be used by some consumer as all of its utilities are interchangeable; such assignment will be performed on demand at the time a consumer actually goes to use a server. In fact, quantum provider 119 might dynamically reassign utilities at its choosing while a consumer is using its utility resources. A quantum package sold to a consumer only requires the quantum provider to guarantee access to the utility as specified in the package. In a sense, generic is a wild card, allowing a quantum provider to substitute any specific quantum utility resource of its own choosing at any time. This on demand allocation is shown in FIG. 7, in which a request specifying a generic designation is received (702), the resources are searched (704), and it is determined whether a match is found (706); if no match is found, the request is queued or denied (708); if a match is found, a specific utility is substituted for the generic designation (710) and allocated on demand (712), the recorded database is updated (714), and where a utility is determined to be idle or not in use (716) the utility is reassigned to a different requesting entity (718). To one skilled in the art, it should be apparent that many alternate forms of constraints on which utilities are being allocated are possible and that the technology disclosed described herein is not intended to describe all possible constraint specifications. However, we envision that queries on the database could be at least as powerful as those allowed by such databases such as SQL.

As its name implies, a provider is also allowed to delist an offering via the Package List/Delist process 142. For example, assume provider 113 wishes to no longer sell a quantum package it had constructed and listed for sale. Provider 113 contacts process 142 via some means along communications path 132 providing a sufficient description of the package it wishes to delist. Process 142 searches the pending DB 148 via communication path 162 for this quantum package. If found, process 142 destroys the matching record in the pending DB 148 and reports success to provider 113 along communications path 132. Otherwise process 142 reports failure. Such a facility obviously also allows a provider to search for arbitrary packages or QU-ETRs, the exact means and capabilities of such queries not specified herein. Similarly, a provider could also search for an delist QU-ETRs using a similar search process.

Quantum Consumers can also search for and bid to purchase quantum packages and QU-ETRs. For example, Package Consumer 180 might contact the Package Search/Bid process 152 via communications path 176. Consumer 180 specifies to process 152 via electronic or other means what type of package is desired and under what purchase terms and conditions. For example, the consumer might say that it requires at least some performance level with some amount of quantum system configuration and capabilities and capacity. The quantum consumer could specify a simple or perhaps complex set of requirements on the quantum package it desires including the range of time windows desired. In addition to package requirements, the consumer must also specify the sales terms. For example, a limit price might be set to pay no more than $8 for this package. Alternatively, a fixed price could be set to-pay exactly $6 for this package. Alternatively assuming the QUE supports this, the purchase terms could be quite complex. For example, purchase this package for no more than $5 unless no package is purchased after 12 am on Dec. 18, 2014, at which time purchase the package at market price. Any number of market purchase terms could be specified. Continuing, once the Package Search/Bid process 152 receives a directive to purchase a package, it records this in a record in the pending DB 148 via a communication path 170 unless a matching sell offer is found before this.

Another quantum purchase scenario might allow a consumer to request a purchase of a large number of packages via a QU-ETR template. For example, assume a consumer 186 wishes to purchase a number of packages of a generic type on or before Dec. 19, 2024. Consumer 186 constructs a QU-ETR definition for these packages using a mechanism similar to the process consumer 180 used above to construct a request for a single package. In this case, consumer 186 specifies a date range, any date on or before Dec. 18, 2024, and a duration as desired, but leaves the utility resource specification as generic or some other means as required. As with the case of a provider creating a QU-ETR record, consumer 186 does not actually care at the time the QU-ETR is created what utility resources will eventually be used as all of servers matching what the consumer wants are interchangeable; such assignment will be performed on demand at the time a consumer actually goes to use a utility. As with the provider case, the consumer here is using generic as a wild card, allowing a match to any provider offering that matches its needs. To one skilled in the art, it should be apparent that many alternate forms of constraints of specifying needs and wants on a consumer's part are possible and that the technology disclosed described herein is not intended to describe all possible constraint specifications. However as before, we envision that queries on the database could be at least as powerful as those allowed by such databases such as SQL. Consumer 186 completes a QU-ETR bid by contacting the Package Search/Bid process 152 via communications path 178. Package Search/Bid process 152 queries the pending DB 152 via communications path 170 for a matching offering and if none is found, records the bid offer in the database. Once either a matching sale bid is found or bid placed, the Package Search/Bid process 152 informs Consumer 186 via path 178 of the status of the bid.

As mentioned for both sale and purchase bid scenarios above, before an entry is created in the pending DB 148 to record a pending sale or purchase order, the processes Package List/Delist 142 and Package Search/Bid 152 must search the DB to see if a pending offer already matches a new request about to be posted. If so, the process doing the search (either 142 or 152) instead of adding a new pending record proceeds to consummate the transaction using an already existing record in the pending DB 148. If multiple offerings match a pending request, the process is free to choose one such pending as it so desires, the means of selection not described here. However for example, it could choose best price on either a buyer or seller behalf, or perhaps choose a record based upon when it was entered in the DB. It should be clear to one skilled in the art that many such decision-making selection algorithms are possible.

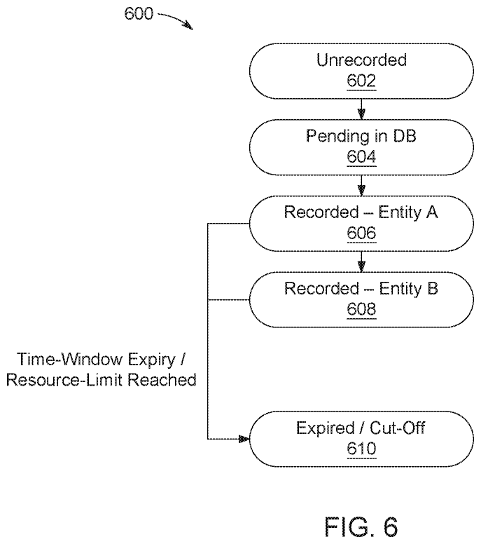

Once a pending offer is selected against a pending request, the process making that selection (142 or 152) delists the pending offer and forwards the sale information to the Package Record process 150 via communication pathway 166 or 174 as appropriate. The Package Record process 150 then notes the sale as completed, recording the sale in the QU-ETR Recorded DB 144 via communications path 168. The QU-ETR Recorded DB 144 will henceforth be referred to as recorded DB for short. It is important that any one package be shown as having only one controlling entity at a time, the entity with current package right of use. Recordation and transfer of package right of use are shown in FIG. 6, in which a package right of use progresses from an unrecorded state (602) to a pending state recorded in the pending DB 148 (604), to a recorded state associated with a first controlling entity in the recorded DB 144 (606), and, upon transfer to a different entity by an updated permission, to a recorded state associated with a second controlling entity (608), and, upon expiration of the time window or when a resource limit is reached, to an expired or cut off state (610), the recordations being performed by the Package Record process 150. The means by which this is implemented in the recorded DB 144 is not specified by this technology disclosed; to those skilled in the art, many such techniques to accomplish uniqueness in a DB should be readily apparent. What is important is that all package right of use transactions must be recorded in the recorded DB such that the entity currently having right of use for a package is known and a description of the package resources and which core providers are providing the resources are also specified (directly or indirectly). This enables the entity with current right of use to actually control and/or employ the quantum utilities resources specified in the package. Continuing, once recorded, the Package Record process 150 may inform all interested parties, the providers directly controlling the resources specified in the package, the entity that created the package sell offering, and the entity purchasing the package that the sale has completed and that package right of use has transferred to the new owner, all of this via communications path 133. The exchange of information regarding packages is through private tunnels and data is encrypted before the tunnel transport and received encrypted on the other end of the tunnel, we are calling this method “trucking”.

Consumers can also function as providers by turning around and creating packages a QU-ETRs and posting them for sale using resources they have acquired package right of use for. This in effect allows consumers to turn into investors or speculators. A consumer might have no intention of actually using any utilities resources in any of the pack-ages or QU-ETRs for they acquire package right of use. Instead, they might simply turn around and offer these packages and QU-ETRs for resale in the QUE. Or they might break apart one or more packages or QU-ETRs and define new packages or QU-ETRs for sale. In FIG. 1, this is accomplished by allowing consumers (180 and 186 as shown in the figure) to communicate with the Package List/Delist process 142 via communications path 172. Such consumers would create packages or QU-ETRs or sell existing packages and QU-ETRs through this process in a manner similar to that employed by providers as described above.

Providers might also be allowed to bid and purchase packages and/or from QU-ETRs in the same manner as consumers. This is shown in FIG. 1 with providers 113 and 119 being able to communicate with the Package Search/Bid process via communications path 173. Being able to purchase packages allows a provider to bundle utilities resources from the packages it has purchased into new packages or in fact use those packages themselves acting as consumers, all this once it has right of use for those packets.

Bids to purchase or sell quantum utilities packages or QU-ETRs might not succeed. For example, a package or QU-ETR transfer expiration time might be exceeded if specified or the time window for a package or QU-ETR might lapse. Or a consumer wishing to purchase a package or QU-ETR might have specified a time limit on such purchase that might have lapsed. In such an event, the Package List/Delist process 142 might optionally inform the provider or consumer defining the package or QU-ETR order that such expiration has occurred via a communication pathways as required (132, 136, 172, 173, 176, or 178).

At some point, an entity with package right of use might want to employ the utilities contained in the associated quantum packet. To do so, it must know where to locate those utilities which means tracing back the resources to the providers that have direct control. Such knowledge must be recorded in the recorded DB 144 in some fashion. The means by which a resource can be used and how a consumer should contact the provider with direct control is not specified herein, although it should be clear to one skilled in the art how one might implement this contact. In FIG. 1, a consumer 180 or 186 contacts a provider 113 or 119 via communications path 175. This path forms the basis for all communications with the resources specified in the package for which it has package right of use.

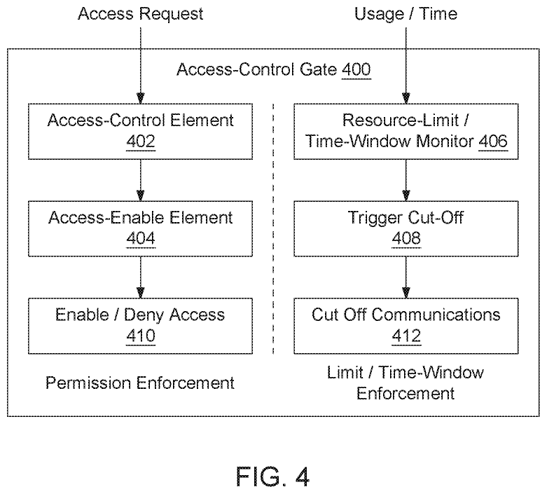

At the termination of path 175 are a pair of Access Control gates 124 and 128. Only two such gates are shown in FIG. 1, but a QUE-based infrastructure may in fact have only one such gate or many such gates. The implementation of the gate may be a combination of hardware and software or just hardware or software alone. The function of each gate is to prevent improper use of a resource by an entity without package right of use for that resource. Each gate is controlled by its provider as shown in FIG. 1 as Access Enable controls 122 and 126. Such an access control gate is shown in FIG. 4 as access control gate 400, which corresponds to the Access Control gates 124 and 128 and the Access Enable controls 122 and 126 of FIG. 1, and which comprises an access control element 402 and an access enable element 404 that together enable or deny access 410 according to package right of use, and a resource limit and time window monitor 406 that, upon a resource limit being reached or the time window expiring, causes a trigger cut off 408 to cut off communications 412.

To determine if access to a resource is to be permitted, a provider (113 or 119 as shown) must first determine if an entity that claims package right of use to a resource does indeed have that right. This can only be accomplished if the provider can first validate that communication along path 175 is in fact from the entity that has package right of use and not some impostor entity such as botnets. The communication for the validation of the right of ownership will take place using private communication tunnel where communication data gets encrypted on both ends, on the provider and consumer sides.

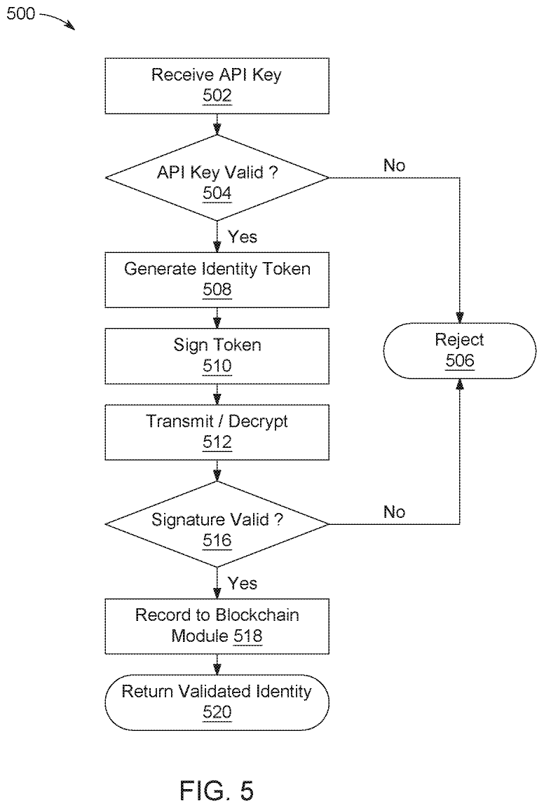

Any number of means to validate identity electronically are possible such as SecureID from RSA (see http://www.rsa.com/node.aspx?id=1156). Alternatively, a system as described in SECURE AND POSITIVE AUTHENTICATION ACROSS A NETWORK may be employed (see United States patent application 20100095117). The exact means by which identification is secured is not specified in this technology disclosed and one skilled in the art can select from any number of such mechanisms. In one embodiment, the identity of the requesting entity is validated as shown in FIG. 5, in which the application programming interface (API) key is received (502) and it is determined whether the API key is valid (504); if the API key is not valid, the request is rejected (506); if the API key is valid, the identity token is generated (508) and signed (510), the information is transmitted and decrypted (512), it is determined whether the digital signature is valid (516), the identity token related activity is recorded to the blockchain module (518), and a validated identity is returned (520).

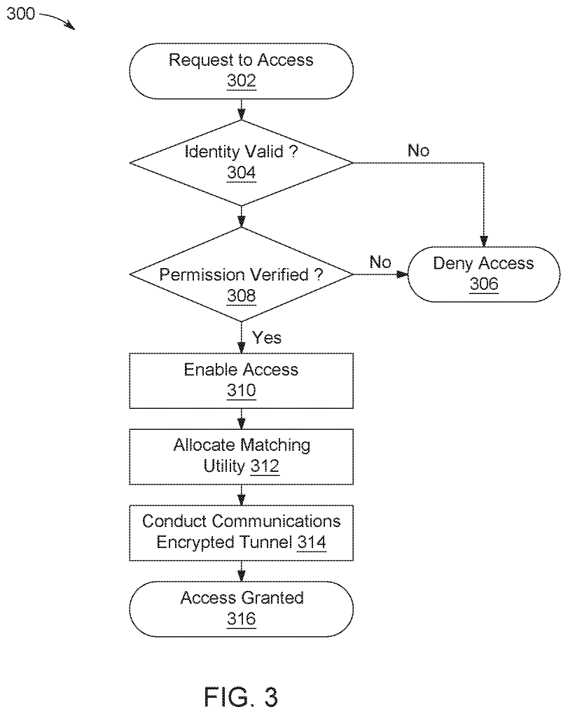

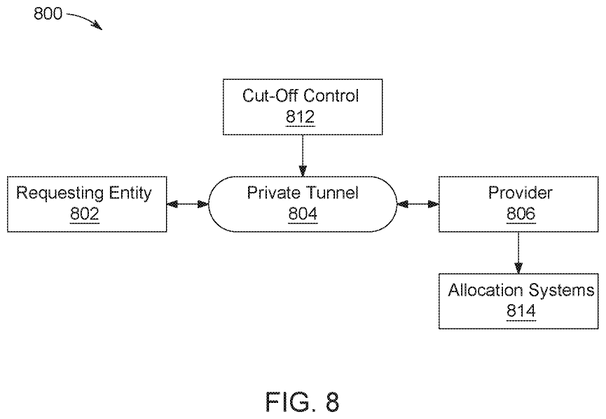

Next, once identity is established, the provider must determine if in fact the requested utilities accesses are granted via a package. To do so, providers contact a Package Validate process 140 in the QUE via communication paths 130 and 134 respectively. Although only two such paths are shown in FIG. 1, there may be in fact only one such connection or in fact many such connections. The Package Validate process 140 responds to queries from the providers asking for validation of package right of use and package definition by searching the recorded DB 144 using path 160 for the most recent recordation of package right of use for a specified package. The Package Validate process 140 then responds either affirmatively or not whether the entity attempting resource use does indeed have that right or whether access should be denied. The Package Validate process 140 uses path 130 or 134 to respond back to the appropriate provider with direct resource control. Once access is granted, an entity with package right of use to re-sources specified in some packet communicates along path 175 as required to gain access to an employ those resources. It is presumed that the provider with direct control of those resources monitors such communication and will cut off this communication if resource limit is reached and/or the time window for the package expires. All these communications will be through private tunnel and the data will be encrypted on both end of the tunnel. This process for controlling access to a resource is shown in FIG. 3, in which a request to access is received (302), it is determined whether the identity is valid (304) and, if not, access is denied (306), it is determined whether the permission is verified by the Package Validate process 140 querying the recorded DB 144 for the most recent recordation (308) and, if not, access is denied (306), and, if verified, access is enabled (310), a matching utility is allocated on demand (312), communications are conducted through the private tunnel (314), and access is granted (316). The private tunnel is shown in FIG. 8 as private tunnel 804 conducting communications between a requesting entity 802 and a provider 806, the data being encrypted on both ends, the provider 806 monitoring the communications and cutting them off by a cut off control 812 upon a resource limit being reached or the time window expiring, and the provider 806 having one or more allocation systems 814 that may share in the workload of providing a resource, the requesting entity 802 and the provider 806 corresponding respectively to a Package Consumer 180 or 186 and a provider 113 or 119 of FIG. 1.

In addition to the ability to sell, purchase, and employ resources via packages and QU-ETRs, the information stored in the pending and recorded databases can be mined to provide any entity in communication with and with access to such mining capabilities invaluable information. Such information could be used for example to predict future use patterns of resources, packages, QU-ETRs, future price projections, etc. The meaning of term data mining and all it implies should be apparent to one skilled in the art.

Note that forgoing description has described the QUE 100 implementation as set of four processes and two databases. Nothing in this technology disclosed is written to imply that this is the only means of implementing a QUE. The above processes could be in fact merged or further split into other processes and implemented in a variety of means. The two databases could be merged into a single database or in fact be split into many databases or various function. It should be apparent to one skilled in the art that there are many possible means of implementing a QUE.

### Post-Quantum Cryptographic Key Lifecycle Management

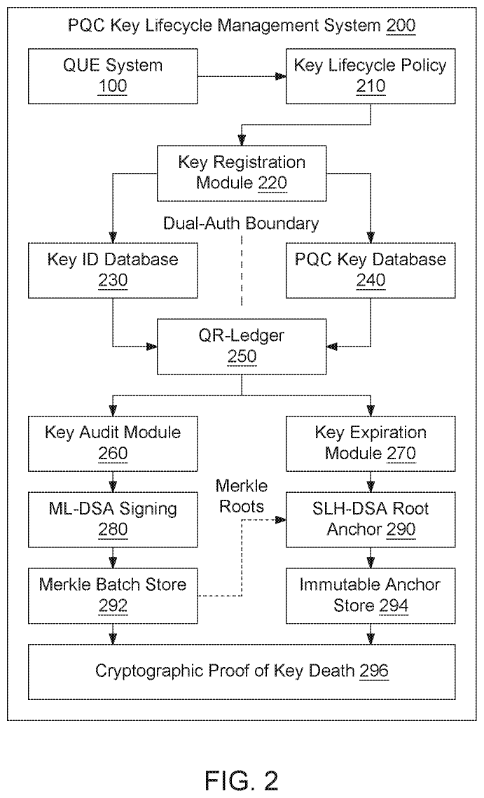

As introduced above, communications between providers, consumers, and the QUE system pass through an internal blockchain module and encrypted private tunnels employing cryptographic digital signatures and identity tokens. To protect these mechanisms, and all other cryptographic operations of the QUE system, against adversaries equipped with cryptographically relevant quantum computers, the QUE system (100) further incorporates a post-quantum cryptographic (PQC) key lifecycle management system (200), shown in FIG. 2 and described below.

The QUE system (100) further implements a time-bounded key discipline enforced through a PQC-aware key lifecycle policy (210), as illustrated in FIG. 2. The PQC key lifecycle management system (200) governs all post-quantum cryptographic key operations within the QUE system. Each cryptographic signing key passes through seven defined lifecycle phases governed by the key lifecycle policy (210): generate, store, distribute, use, rotate, archive, and destroy. This lifecycle is documented in a formal Key Lifecycle Policy (210) that governs all post-quantum digital signature operations within the system. As used herein, ML-DSA refers to the Module Lattice-Based Digital Signature Algorithm standardized by the National Institute of Standards and Technology (NIST) as Federal Information Processing Standard (FIPS) 204. ML-DSA is a post-quantum classical cryptographic algorithm. It executes on conventional classical computing hardware but is designed to resist attacks from cryptographically relevant quantum computers. ML-DSA security is based on the hardness of the Module Learning With Errors (Module-LWE) lattice problem, for which no efficient quantum algorithm is known. As used herein, SLH-DSA refers to the Stateless Hash-Based Digital Signature Algorithm standardized by NIST as FIPS 205. SLH-DSA is likewise a post-quantum classical cryptographic algorithm whose security is founded exclusively on the properties of cryptographic hash functions (SHA-2 and SHAKE families), which are considered inherently quantum-resistant because no known quantum algorithm provides more than a quadratic speedup against them. Within the key lifecycle management architecture (200) described herein and shown in FIG. 2, ML-DSA signing (280) is employed for frequent, operational signing of key events, log entries, and attestations due to its speed and moderate signature size, while SLH-DSA root anchoring (290) is employed for infrequent, high-assurance root anchoring operations due to its maximally conservative, hash-based security foundation.

As used herein, a quantum-resistant distributed ledger (hereinafter “QR-Ledger”) (250) is a distributed, append-only ledger architecture in which all entries (including key registration records, validity window parameters, rotation events, and proofs of key retirement) are cryptographically secured exclusively using post-quantum signature schemes, specifically ML-DSA signing (280) (NIST FIPS 204) for operational signing and SLH-DSA root anchoring (290) (NIST FIPS 205) for periodic root anchoring. No entry on the QR-Ledger (250) is accepted or considered valid unless accompanied by a conforming post-quantum digital signature. The QR-Ledger (250) is maintained across multiple independent nodes such that no single entity controls the ledger, and any participant may independently verify the authenticity and integrity of any record without reliance on a central certificate authority. A key registration module (220) records post-quantum public keys generated using ML-DSA signing (280) on the QR-Ledger (250), together with validity window parameters specifying the maximum operational lifetime of each key. Each registered key is assigned a unique key identifier (key ID or “kid”) and published in an authenticated key set (e.g., JWK format or gRPC metadata) listing all currently valid keys. Key IDs are stored in a key ID database (230) that references a separate PQC key database (240) in which the PQC signing key material itself resides, providing a dual-authentication security boundary such that compromise of a key ID stored in the key ID database (230) does not yield direct access to the PQC key database (240), access to which requires a separate authentication factor.

The QR-Ledger (250) is distinct from the internal blockchain module described herein with respect to quantum computing resource transaction verification. The internal blockchain module cryptographically verifies package right of use for quantum computing resource transactions and is a general-purpose distributed ledger component of the QUE system (100). The QR-Ledger (250), by contrast, is a specialized ledger component of the PQC key lifecycle management system (200) dedicated exclusively to post-quantum cryptographic key lifecycle management. While both components employ distributed ledger architecture to provide tamper-evident, decentralized recordkeeping, the QR-Ledger (250) is distinguished by three specific properties that the internal blockchain module does not require: (a) all ledger entries on the QR-Ledger (250) are signed exclusively with post-quantum signature schemes, specifically ML-DSA signing (280) for operational key events and SLH-DSA root anchoring (290) for periodic Merkle root anchoring, such that no entry signed with a classical signature algorithm (e.g., ECDSA or RSA) is accepted as valid; (b) the QR-Ledger (250) records cryptographic key lifecycle events specifically, including key registration records from the key registration module (220), validity window parameters, rotation records from the key expiration module (270), and cryptographic proofs of key death (296), rather than resource transaction records; and (c) records on the QR-Ledger (250) are independently verifiable by any participant without trust in a central certificate authority, providing a decentralized root of trust for post-quantum key management that remains secure against an adversary equipped with a cryptographically relevant quantum computer.

A key audit module (260) continuously monitors key usage events, attestations, and log entries signed using ML-DSA signing (280). A key expiration module (270) monitors validity windows for each registered key on the QR-Ledger (250) and triggers rotation workflows when a key approaches or reaches its defined maximum operational lifetime. Time-based rotation (e.g., every 24 hours for high-value log signing operations) is enforced for both ML-DSA and FN-DSA signing keys. Each log record or batch-signature record stored in the Merkle batch store (292) includes: (a) the key id used for signing; (b) an algorithm identifier specifying the post-quantum signature scheme and parameter set (e.g., ML-DSA-65, ML-DSA-87, or SLH-DSA parameter set); and (c) a signing_time and a monotonic sequence or batch identifier. To reduce per-event signature overhead, the system signs batches of log entries using ML-DSA signing (280) and stores a Merkle tree root in the Merkle batch store (292) rather than signing each event independently. Periodically, a “super-block” hash of all batches is signed using SLH-DSA root anchoring (290) and stored in an immutable anchor store (294) or external transparency log, creating a hierarchical anchoring structure in which frequent ML-DSA batch signatures are periodically committed under a longer-lived SLH-DSA root.

The ML-DSA-based key rotation cycle, triggered by the key expiration module (270) and governed by the key lifecycle policy (210), proceeds through the following steps as illustrated in FIG. 2. First, a pre-staging step generates a new ML-DSA key pair in a Hardware Security Module (HSM) or equivalent secure module, registers the key with the key management service (KMS/PKI) via the key registration module (220), assigns a key id stored in the key ID database (230), and adds the key to the authenticated key set as “pending/secondary.” Second, an update-signers step distributes the new private key material stored in the PQC key database (240) exclusively to authorized log signer instances (e.g., STEM or log gateway components) and updates configuration so that after a defined cut-over time, signers select the new key for all newly created batches and log entries. Third, a cut-over and overlap step commences ML-DSA signing (280) of new log entries with the new key id at the cut-over time while the old key remains accessible for verification of log entries and late-arriving batches belonging to the previous epoch. Verifiers read the key id from each log signature and retrieve the corresponding public key from the authenticated key set; the system does not assume that only one key is active at any time, thereby enabling continuous verification across rotation boundaries without interruption. Fourth, an anchor-and-archive step computes a Merkle root of all logs signed with the retiring key after the old key's log window is fully closed, signs that Merkle root using SLH-DSA root anchoring (290), and stores the root together with metadata comprising the old key_id, time window, and algorithm parameters in the immutable anchor store (294). Fifth, a key retirement step marks the old key as “Cemetery-route” for a compliance grace period, moves the private key material from the PQC key database (240) to encrypted archive via a one-way process, and destroys private key material in accordance with applicable compliance requirements. The old key is removed from the live verification key set once all relevant logs are anchored in the immutable anchor store (294) and no active clients require access to it.

Upon retirement of a post-quantum signing key, the PQC key lifecycle management system (200) generates a cryptographic proof of key death (296): a signed, ledger-recorded attestation that a given key has been permanently retired and that its private key material has been destroyed or archived in accordance with the key lifecycle policy (210). This proof of key death (296) is recorded on the QR-Ledger (250) and is independently verifiable by any participant without reliance on a central certificate authority, thereby providing a decentralized, tamper-evident record of the complete key lifecycle from generation through destruction, as governed by the key lifecycle policy (210) and illustrated in FIG. 2. The cryptographic proof of key death (296) enables any relying party to confirm, without contacting a central authority, that a given key identifier stored in the key ID database (230) is no longer operationally active, and that any signature presented as having been made with that key after the recorded retirement time should be treated as invalid.

### Technical Advantages of the Disclosed Architecture

The architecture described herein constitutes a specific technical solution to the technical problem of over-allocation and unauthorized concurrent access of scarce quantum hardware in a multi-provider, multi-consumer distributed environment: a problem that cannot be solved by conventional scheduling databases or generic blockchain implementations alone. The technical problem arises because quantum computing resources are physically scarce, time-sensitive, and shared across multiple independent providers and consumers, making it impossible for any single provider's access-control system to prevent unauthorized concurrent usage without a coordinating, authoritative registry. The present technology solves this technical problem through the following specific computer-implemented mechanisms: First, the Recorded Database enforces a uniquely-constrained, single-entity package right of use that prevents more than one entity from controlling any defined quantum computing resource during any specified time window: a system-level constraint that cannot be implemented as a purely mental or paper-based process. Second, the automatic delisting of packages or QU-ETRs from the Recorded Database upon expiry of the time window or upon reaching a defined utility limit programmatically frees resources for re-allocation without human intervention, eliminating underutilization caused by stale or expired reservations. Third, the internal blockchain module gates all quantum workload execution by cryptographically verifying, prior to granting access, that the requesting entity currently holds valid package right of use for the specific resources requested: an access-control mechanism that prevents botnets or impostor entities from consuming quantum hardware resources they have not legitimately acquired. These three mechanisms, operating together as a computer-implemented architecture, improve the technical functioning of distributed quantum computing resource management in a manner that is not achievable through conventional general-purpose computing or prior art marketplace systems.

The claims of the present technology disclosed are not directed to an abstract idea. The concept of a time-window-constrained, market-based exchange for computing resources has concrete, real-world grounding: Amazon Web Services has operated a Spot Instance marketplace since 2009 in which excess classical cloud computing capacity is allocated to consumers via market-determined pricing for defined time windows, with automatic resource reclamation upon expiry, demonstrating that such exchange mechanisms are practical, implementable, and commercially viable computer-implemented systems rather than abstract mental concepts or mathematical relationships. The present technology disclosed applies and extends this proven, concrete marketplace model to the specific and previously unsolved technical domain of quantum computing utilities, and further adds three specific computer-implemented technical mechanisms that are entirely absent from classical cloud spot markets and that cannot be performed in the human mind or on paper: (a) enforcement, at the system level via the Recorded Database, of a uniquely-constrained single-entity package right of use that prevents more than one entity from controlling any defined quantum computing resource during any specified time window: a constraint that requires real-time, machine-enforced state management across a distributed multi-provider environment; (b) blockchain-gated quantum workload execution, in which the internal blockchain module cryptographically verifies current package right of use prior to permitting any quantum workload to access the requested resources: an access-control mechanism that operates at the computer-system level and prevents unauthorized concurrent usage that classical scheduling systems cannot prevent in a multi-provider quantum environment; and (c) a post-quantum cryptographic key lifecycle management architecture, comprising a key registration module, key audit module, key expiration module, time-bounded key rotation workflow, and cryptographic proof of key death, all secured using ML-DSA (NIST FIPS 204) and SLH-DSA (NIST FIPS 205) on a quantum-resistant distributed ledger (QR-Ledger), a concrete cryptographic infrastructure with no analog in classical cloud computing spot markets. These three mechanisms, grounded in the concrete technical precedent of existing classical cloud resource exchanges and further distinguished by quantum-specific technical requirements, confirm that the present claims are directed to a specific improvement in distributed quantum computing resource management technology, not to an abstract idea.

### Artificial Intelligence and Machine Learning Implementations

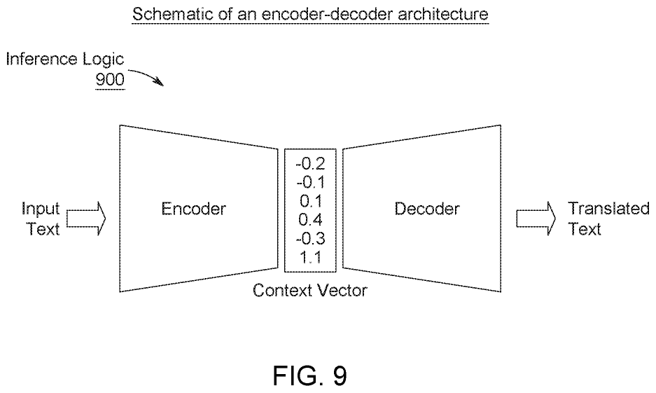

As introduced above, buyers of quantum computing utilities may invoke AI prompt action to request package information, to obtain the best solution to a problem, to simulate a problem, or to search for particular information using quantum machine learning or other artificial intelligence techniques. The following describes example implementations of artificial intelligence and machine learning systems, referred to herein as the disclosed AI system, that may be employed for these purposes, together with FIGS. 9 to 18.

### Examples of Artificial Intelligence and Machine Learning Techniques

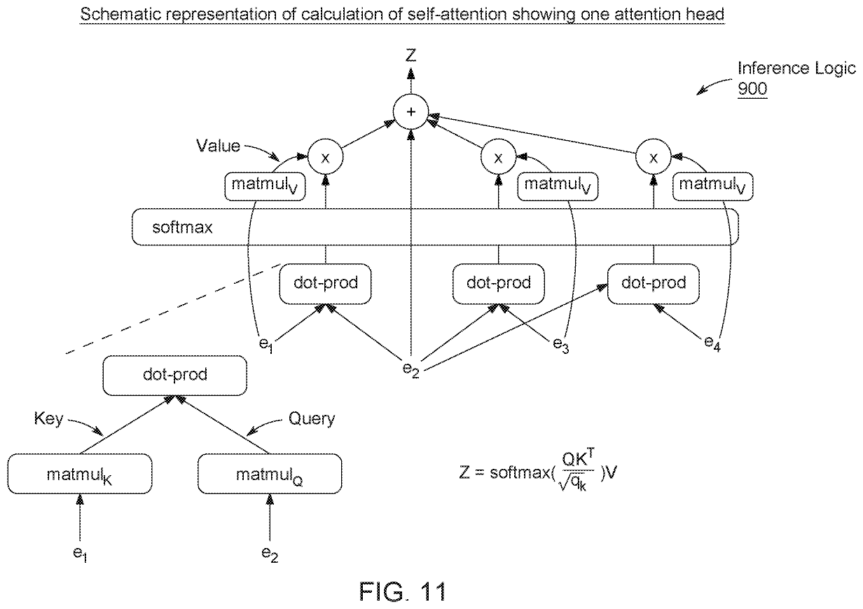

The system described in conjunction with FIG. 2 and FIGS. 11 comprises one or more subsystems based on Artificial Intelligence (AI). Implementation of these subsystems based on the Artificial Intelligence (AI) subsystems, techniques and models is illustrated by FIGS. 9 to 11.

Some implementations of the technology disclosed relate to using a Transformer model to provide an AI system. In particular, the technology disclosed proposes an AI management system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, one or more of the disclosed AI system (and subsystems) are a multilayer perceptron (MLP). In another implementation, the disclosed AI system and subsystems are a feedforward neural network. In yet another implementation, the disclosed AI system and subsystems are a fully connected neural network. In a further implementation, the disclosed AI system and subsystems are a fully convolution neural network. In a yet further implementation, the disclosed AI system and subsystems are a semantic segmentation neural network. In a yet another further implementation, the disclosed AI system and subsystems are a generative adversarial network (GAN) (e.g., CycleGAN, StyleGAN, pixelRNN, text-2-image, DiscoGAN, IsGAN). In a yet another implementation, the disclosed AI system and subsystems include self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLaMA versions, BERT, SpanBERT, RoBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the technology disclosed (also referred to as an AI system and AI subsystems) uses a convolution neural network (CNN) with a plurality of convolution layers. In another implementation, the disclosed uses a recurrent neural network (RNN) such as a long short-term memory network (LSTM), bi-directional LSTM (Bi-LSTM), or a gated recurrent unit (GRU). In yet another implementation, the technology disclosed includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

FIG. 9 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

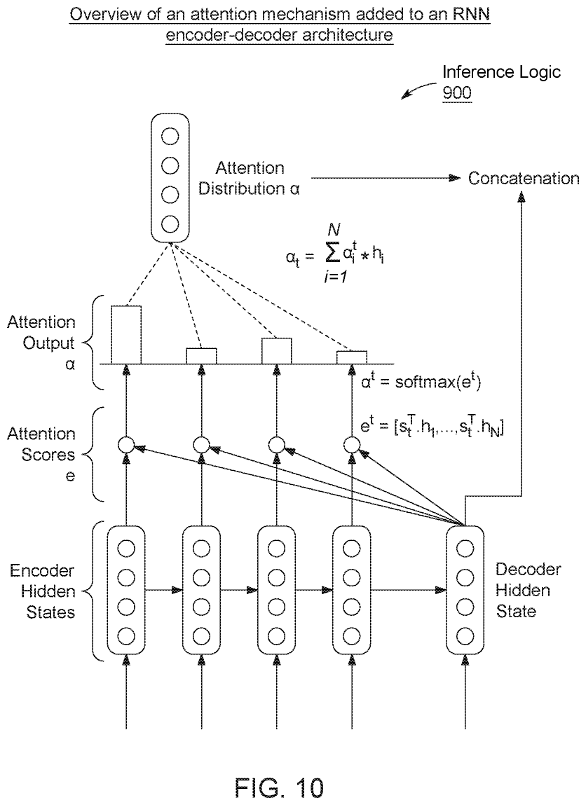

Attention mechanisms distinguish Transformers from other machine learning models. The attention mechanism provides a solution for the vanishing gradient problem. FIG. 10 shows an overview of an attention mechanism added onto an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use 1D convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

Multi-headed attention is executed in the Transformer. FIG. 11 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

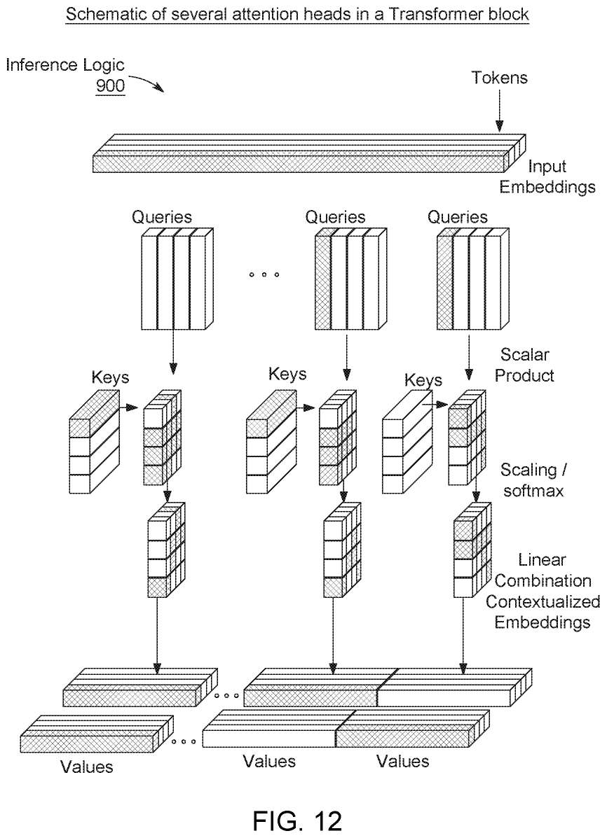

FIG. 12 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{{QK}^{T}}{\sqrt{dk}} ) V$$

where Q, K, V are computed as:

X·W_{Q},X·W_{K},X·W_{V}

X is the input matrix and W_{Q}, W_{K}, W_{V} are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

MultiHeadAttention(Q,K,V)=[head₁, . . . ,headₕ]W₀where headᵢ=Attention

$$( {QW}_{i}^{Q} , {KW}_{i}^{K} , {VW}_{i}^{V} )$$

The outputs of all heads are concatenated together and projected again using the learned weights matrix W₀ to match the dimensions expected by the next block of heads or the output of the Transformer. Using the multi-head attention instead of the simpler scaled dot-product attention enables Transformers to jointly attend to information from different representation subspaces at different positions.

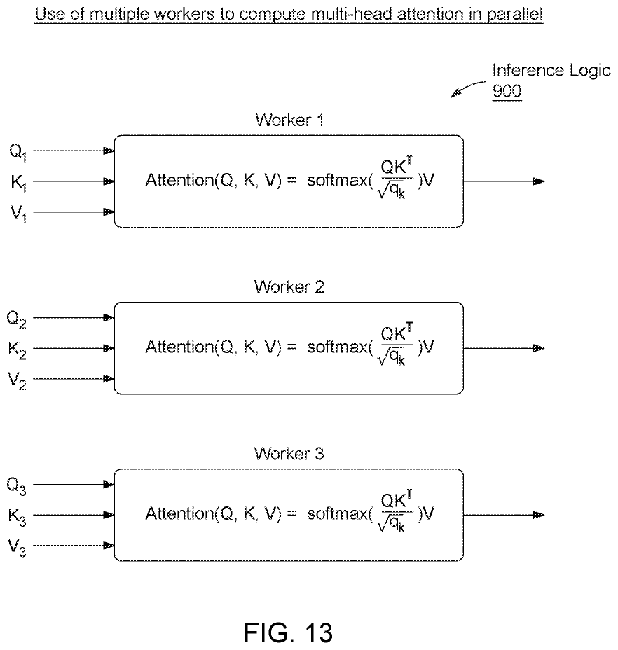

As shown in FIG. 13, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

a·b·c

For matrices of shape (a, b) and (c, d), to obtain values Q, K, V, we need to compute the operations:

X·W_{Q},X·W_{K},X·W_{V}

The matrix X is of shape (n, d) where n is the number of patches and d is the hidden vector dimension. The weights W_{Q}, W_{K}, W_{V} are all of shape (d, d). Omitting the constant factor 3, the resulting complexity is:

n·d²

We can proceed to the ₑₛₜᵢₘₐₜᵢₒₙ of the complexity of the attention function itself, i.e., of

$$SoftMax ( \frac{{QK}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

n²·d

Scaling by a constant factor of dk, where dk is the dimension of the keys vector, as well as applying the SoftMax function, both have the complexity of a·b for a matrix of shape (a, b), hence they do not influence the asymptotic complexity.

$$Lastly the dot product SoftMax ( \frac{{QK}^{T}}{\sqrt{dk}} ) .$$

V is between matrices of shapes (n, n) and (n, d) and so its complexity is:

n²·d

The final asymptotic complexity of scaled dot-product attention is obtained by summing the complexities of computing Q, K, V, and of the following attention function:

n·d²+n²·d.

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

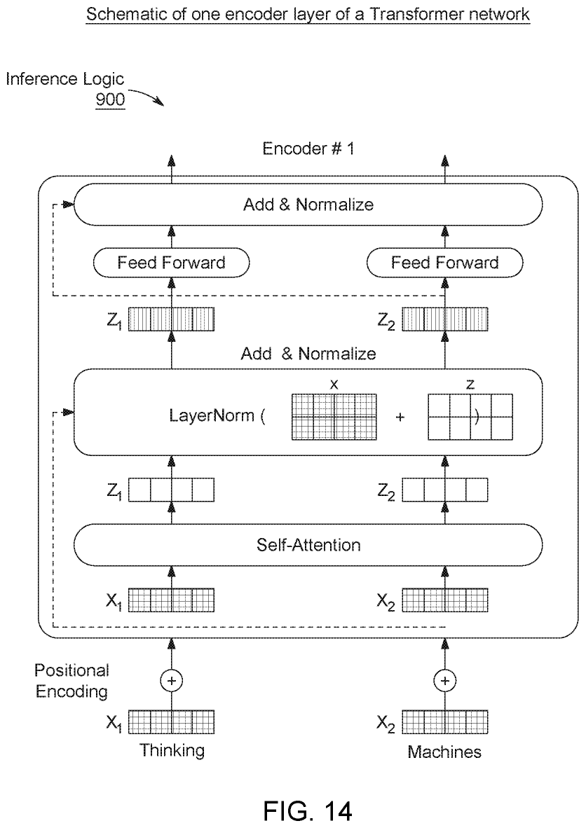

FIG. 14 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

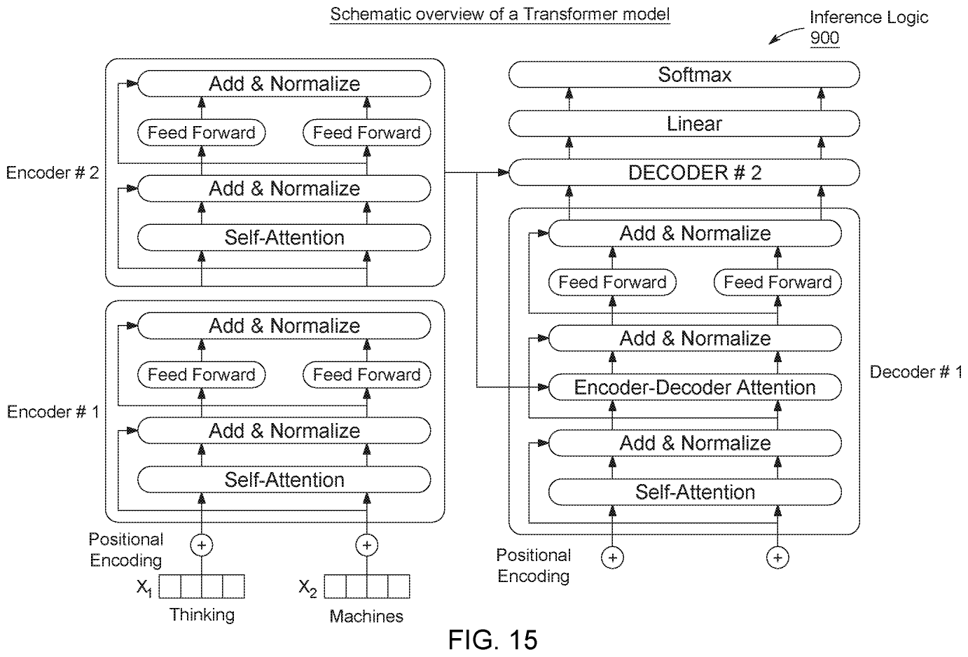

FIG. 15 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

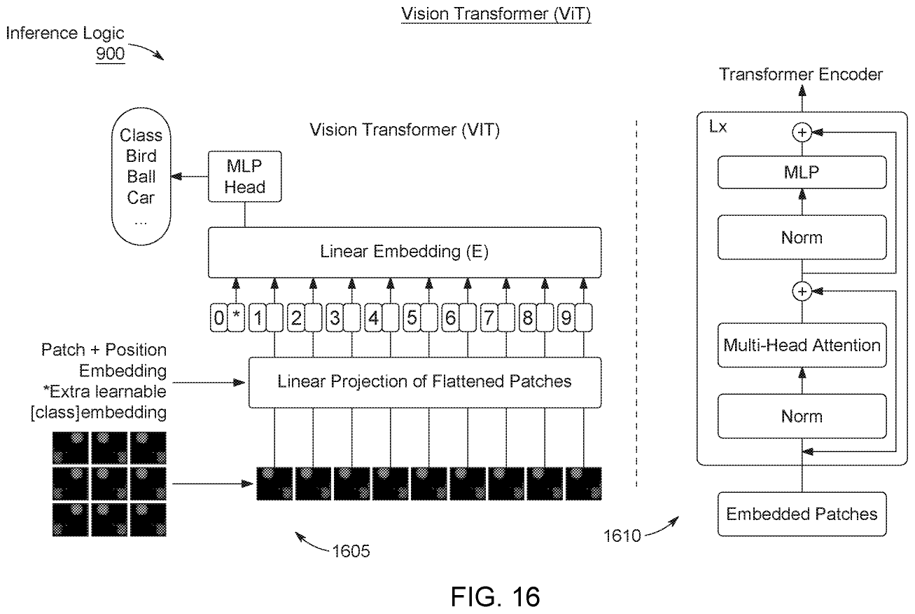

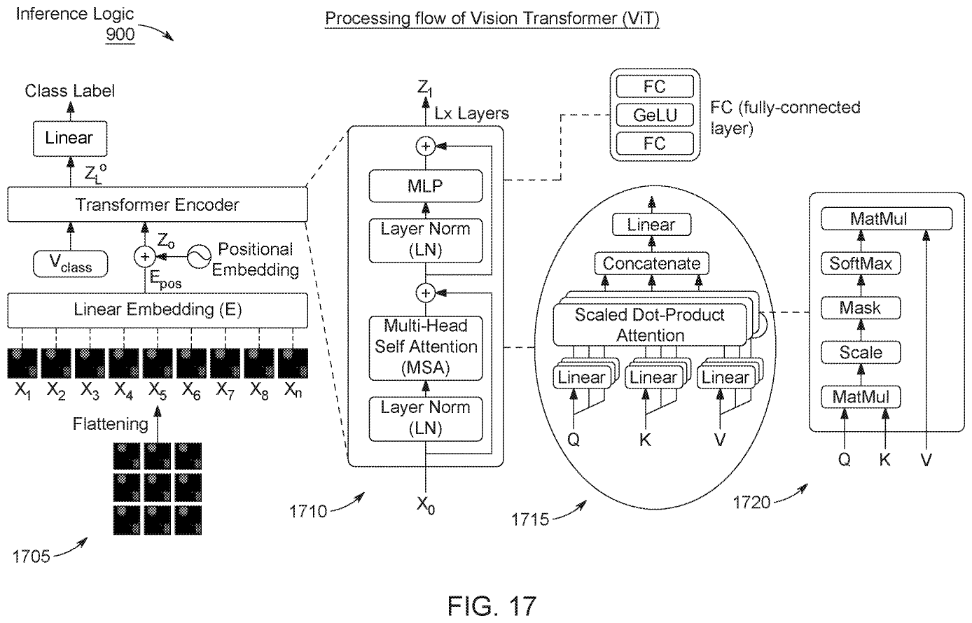

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 16 (1605, 1610) and FIG. 17 (1705, 1710, 1715, 1720). Unfortunately, important positional information is lost because image sets are position-invariant. This problem is solved by adding a learned positional encoding into the image patches.

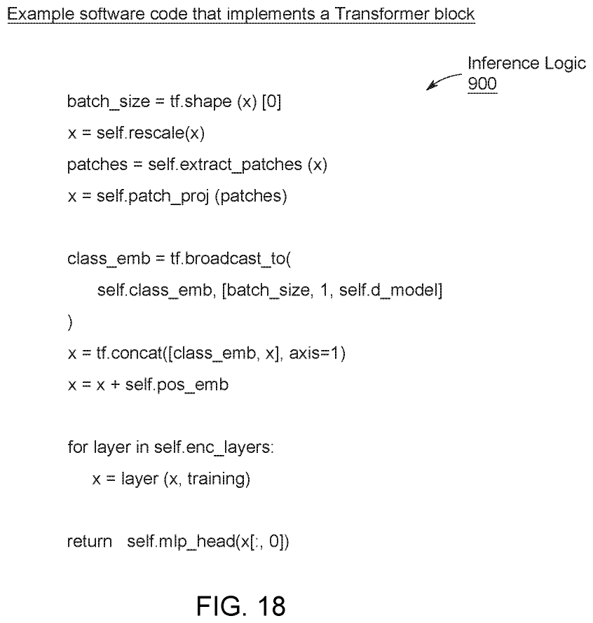

The computations of the ViT architecture can be summarized as follows. The first layer of a ViT extracts a fixed number of patches from an input image (1605 in FIG. 16). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 18.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block 1610 in FIG. 16, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input. In the following sections, details of the subsystem are presented.

### Computer System

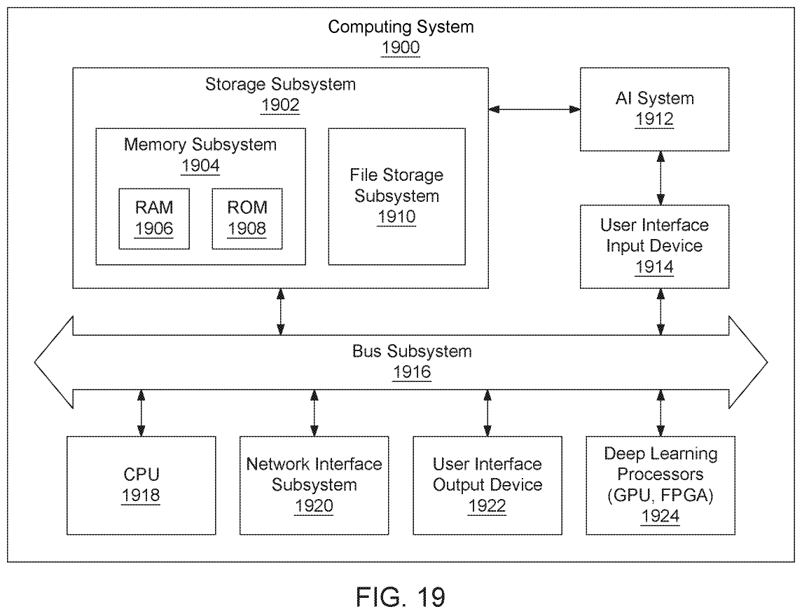

FIG. 19 shows an example computer system 1900 that can be used to implement the technology disclosed. Computer system 1900 includes at least one central processing unit (CPU) 1918 that communicates with a number of peripheral devices via bus subsystem 1916. These peripheral devices can include a storage subsystem 1902 including, for example, memory devices and a file storage subsystem 1910, user interface input devices 1914, user interface output devices 1922, and a network interface subsystem 1920. The input and output devices allow user interaction with computer system 1900. Network interface subsystem 1920 provides an interface to outside networks, including an interface to corresponding interface devices in other computer systems. Storage subsystem (1902) is further communicably coupled to an AI system (1912), also referred to herein as the disclosed AI system, which is further communicably coupled to the user interface input devices (1914), the AI system (1912) being configured to implement the artificial intelligence and machine learning techniques described herein with reference to FIGS. 9 to 18.

In one implementation, the disclosed subsystem are communicably linked to the storage subsystem 1902 and the user interface input devices 1914.

User interface input devices 1914 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1900.

User interface output devices 1922 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1900 to the user or to another machine or computer system.

Storage subsystem 1902 stores programming and data constructs that provide the functionality of some or all of the modules and methods described herein. These software modules are generally executed by processors 1924.

Processors 1924 can be graphics processing units (GPUs), field-programmable gate arrays (FPGAs), application-specific integrated circuits (ASICs), and/or coarse-grained reconfigurable architectures (CGRAs). Processors 1924 can be hosted by a deep learning cloud platform such as Google Cloud Platform™, Xilinx™, and Cirrascale™. Examples of processors 1924 include Google's Tensor Processing Unit (TPU)™, rackmount solutions like GX4 Rackmount Series™, GX13 Rackmount Series™, NVIDIA DGX-1™, Microsoft′ Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1904 used in the storage subsystem 1902 can include a number of memories including a main random access memory (RAM) 1906 for storage of instructions and data during program execution and a read only memory (ROM) 1908 in which fixed instructions are stored. A file storage subsystem 1910 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1910 in the storage subsystem 1902, or in other machines accessible by the processor.

Bus subsystem 1916 provides a mechanism for letting the various components and subsystems of computer system 1900 communicate with each other as intended. Although bus subsystem 1916 is shown schematically as a single bus, alternative implementations of the bus subsystem can use multiple busses.

Computer system 1900 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1900 depicted in FIG. 19 is intended only as a specific example for purposes of illustrating the preferred implementations of the present technology disclosed. Many other configurations of computer system 1900 are possible having more or less components than the computer system depicted in FIG. 19.

In various implementations, a learning system is provided. In some implementations, a feature vector is provided to a learning system. Based on the input features, the learning system generates one or more outputs. In some implementations, the output of the learning system is a feature vector. In some implementations, the learning system comprises an SVM. In other implementations, the learning system comprises an artificial neural network. In some implementations, the learning system is pre-trained using training data. In some implementations training data is retrospective data. In some implementations, the retrospective data is stored in a data store. In some implementations, the learning system may be additionally trained through manual curation of previously generated outputs.

In some implementations, an object detection pipeline is a trained classifier. In some implementations, the trained classifier is a random decision forest. However, it will be appreciated that a variety of other classifiers are suitable for use according to the present disclosure, including linear classifiers, support vector machines (SVM), or neural networks such as recurrent neural networks (RNN).

Suitable artificial neural networks include but are not limited to a feedforward neural network, a radial basis function network, a self-organizing map, learning vector quantization, a recurrent neural network, a Hopfield network, a Boltzmann machine, an echo state network, long short term memory, a bi-directional recurrent neural network, a hierarchical recurrent neural network, a stochastic neural network, a modular neural network, an associative neural network, a deep neural network, a deep belief network, a convolutional neural networks, a convolutional deep belief network, a large memory storage and retrieval neural network, a deep Boltzmann machine, a deep stacking network, a tensor deep stacking network, a spike and slab restricted Boltzmann machine, a compound hierarchical-deep model, a deep coding network, a multilayer kernel machine, or a deep Q-network.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

FIG. 19 is a schematic of an exemplary computer system or computing node (also referred to as a network node). Computing node 1900 is only one example of a suitable computing node and is not intended to suggest any limitation as to the scope of use or functionality of embodiments described herein. Regardless, computing node 1900 is capable of being implemented and/or performing any of the functionality set forth hereinabove. As used herein, the computing node (or network node) is an addressable hardware device or virtual device that is attached to a network, and is capable of sending, receiving, or forwarding information over a communications channel to or from other network nodes. Examples of electronic devices which can be deployed as hardware network nodes include all varieties of computers, workstations, laptop computers, handheld computers, and smartphones. Computing nodes or network nodes can be implemented in a cloud-based server system and/or a local system. More than one virtual device configured as a network node can be implemented using a single physical device.

In the Computing node 1900 there is a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, mobile computing devices including mobile phones, multiprocessor systems, microprocessor-based systems, set top boxes, programmable consumer electronics, network PCs, minicomputer systems, mainframe computer systems, and distributed computing environments that include any of the above systems or devices, and the like.

Computer system/server may be described in the general context of computer system-executable instructions, such as program modules, being executed by a computer system. Generally, program modules may include routines, programs, objects, components, logic, data structures, and so on that perform particular tasks or implement particular abstract data types. Computer system/server may be practiced in distributed computing environments where tasks are performed by remote processing devices that are linked through a communications network. In a distributed computing environment, program modules may be located in both local and remote computer system storage media including memory storage devices.

As shown in FIG. 19, computer system/server in computing node 1900 is shown in the form of a general-purpose computing device. The components of computer system/server may include, but are not limited to, one or more processors or processing units, a system memory, and a bus that couples various system components including system memory to processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server typically includes a variety of computer system readable media. Such media may be any available media that is accessible by computer system/server, and it includes both volatile and non-volatile media, removable and non-removable media.

System memory can include computer system readable media in the form of volatile memory, such as random access memory (RAM) and/or cache memory. Algorithm Computer system/server may further include other removable/non-removable, volatile/non-volatile computer system storage media. By way of example only, storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus by one or more data media interfaces. As will be further depicted and described below, memory may include at least one program product having a set (e.g., at least one) of program modules that are configured to carry out the functions of embodiments of the disclosure.

Program/utility, having a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments as described herein.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some implementations, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to implementations of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various implementations of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

From the foregoing description, it will thus be evident that the present technology disclosed provides what is covered. As various changes can be made in the above embodiments and operating methods without departing from the spirit or scope of the following claims, it is intended that all matter contained in the above description or shown in the accompanying drawings should be interpreted as illustrative and not in a limiting sense.

Variations or modifications to the design and construction of this technology disclosed, within the scope of the appended claims, may occur to those skilled in the art upon reviewing the disclosure herein (especially to those using computer aided design systems). Such variations or modifications, if within the spirit of this technology disclosed, are intended to be encompassed within the scope of any claims to patent protection issuing upon this technology disclosed.

What is claimed is:

1. A method for controlling access to networked computing resources, the method comprising:
executing, by one or more processors, instructions stored on one or more non-transitory computer-readable media to perform operations comprising:
receiving, from a requesting entity, a request to access a quantum-computing utility of a resource;
receiving, from the requesting entity, an application programming interface (API) key associated with the requesting entity;
generating, upon a determination that the API key is valid, an identity token signed with a cryptographic digital signature;
validating, using the identity token, an identity of the requesting entity by verifying the cryptographic digital signature of the identity token to establish a validated identity;
the resource being one of a plurality of resources stored in a database;
the resource comprising a collection of one or more quantum-computing utilities that may be controlled over a time window;
the resource associated with a provider entity having direct control over the collection;
the quantum-computing utility being one of the collection;
a recorded database storing a permission to access that associates a single entity with each resource of the plurality of resources;
restricting each resource of the plurality of resources to only one controlling entity at a time;
determining, for the validated identity, a permission of the requesting entity to access the resource by querying the recorded database for a current recordation of the permission to access for the resource;
granting access to the quantum-computing utility at an access-control gate based on the permission of the requesting entity;
allocating, on demand, an interchangeable one of the quantum-computing utilities that matches the request;
communicating, through a private tunnel encrypted at both ends, with the requesting entity; and
recording and enforcing the permission to access through an internal blockchain module.

2. The method of claim 1, further comprising cutting off communications with the requesting entity responsive to a determination that a resource limit is reached or that the time window expires.

3. The method of claim 1, wherein granting access to the quantum-computing utility comprises establishing, at the access-control gate, a network connection between the requesting entity and the quantum-computing utility, and wherein the access-control gate blocks the network connection when the permission of the requesting entity is not confirmed by the current recordation.

4. The method of claim 1, wherein determining the permission is performed by a package validate process that queries the recorded database at the time of the request to confirm the current recordation before access is granted at the access-control gate.

5. The method of claim 1, further comprising recording the permission to access as a pending recordation in a pending database and, upon confirmation, as the current recordation in the recorded database.

6. The method of claim 1, wherein recording and enforcing the permission to access comprises appending the permission to access as a block in an append-only chain of the internal blockchain module, each block cryptographicaly linked to a preceding block, and resolving the current recordation for the resource from the cryptographically linked chain to determine whether access to the resource is to be permitted.

7. The method of claim 1, wherein validating the identity of the requesting entity comprises decrypting information received from the requesting entity using the identity token to form decrypted information, validating the cryptographic digital signature, and denying access to the requesting entity responsive to a failure of the validating.

8. The method of claim 1, wherein allocating the interchangeable one of the quantum-computing utilities comprises comparing the request against available quantum-computing utilities and substituting a generic quantum-computing utility with a specific quantum-computing utility that matches the request.

9. The method of claim 1, wherein the collection of one or more quantum-computing utilities is associated with a resource limit, and access to the quantum-computing utility is granted only while the resource limit is not exceeded and the time window has not expired.

10. The method of claim 1, further comprising reassigning the permission to access from the single entity to a different entity by recording, in the recorded database, an updated permission associating the resource with the different entity.

11. The method of claim 1, further comprising distributing a workload of providing the resource across a plurality of allocation systems that share the workload.

12. The method of claim 1, further comprising searching the plurality of resources to identify the resource as matching the request and updating the recorded database to allocate the resource to the requesting entity.

13. The method of claim 1, further comprising identifying a quantum-computing utility of the collection that is idle or not in use and reassigning the idle or unused quantum-computing utility to a different requesting entity.

14. A system for controlling access to networked computing resources, comprising:
one or more processors and one or more non-transitory computer-readable media storing instructions that, when executed by the one or more processors, cause the one or more processors to:
receive, from a requesting entity, a request to access a quantum-computing utility of a resource;
receive, from the requesting entity, an application programming interface (API) key associated with the requesting entity;
generate, upon a determination that the API key is valid, an identity token signed with a cryptographic digital signature;
validate, using the identity token, an identity of the requesting entity by verifying the cryptographic digital signature of the identity token to establish a validated identity;
store, in a recorded database, a permission to access that associates a single entity with each resource of a plurality of resources;
restrict each resource of the plurality of resources to only one controlling entity at a time;
determine, for the validated identity, a permission of the requesting entity to access the resource by querying the recorded database for a current recordation of the permission to access for the resource;
grant access to the quantum-computing utility at an access-control gate based on the permission of the requesting entity;
allocate, on demand, an interchangeable one of the quantum-computing utilities that matches the request;
communicate, through a private tunnel encrypted at both ends, with the requesting entity;
record and enforce the permission to access through an internal blockchain module;
wherein the resource is one of the plurality of resources stored in a database;
wherein the resource comprises a collection of one or more quantum-computing utilities that may be controlled over a time window;
wherein the resource is associated with a provider entity having direct control over the collection; and
wherein the quantum-computing utility is one of the collection.

15. The system of claim 14, wherein the instructions further cause the one or more processors to cut off communications with the requesting entity responsive to a determination that a resource limit is reached or that the time window expires.

16. The system of claim 14, wherein the instructions further cause the one or more processors to perform a package validate process that queries the recorded database at the time of the request to confirm the current recordation before access is granted at the access-control gate.

17. The system of claim 14, wherein the instructions further cause the one or more processors to record the permission to access as a pending recordation in a pending database and, upon confirmation, as the current recordation in the recorded database.

18. The system of claim 14, wherein the instructions further cause the one or more processors to compare the request against available quantum-computing utilities and substitute a generic quantum-computing utility with a specific quantum-computing utility that matches the request.

19. The system of claim 14, wherein the instructions further cause the one or more processors to identify a quantum-computing utility of the collection that is idle or not in use and reassign the idle or unused quantum-computing utility to a different requesting entity.

20. A non-transitory computer-readable medium storing instructions that, when executed by one or more processors, cause the one or more processors to:
receive, from a requesting entity, a request to access a quantum-computing utility of a resource;
receive, from the requesting entity, an application programming interface (API) key associated with the requesting entity;
generate, upon a determination that the API key is valid, an identity token signed with a cryptographic digital signature;
validate, using the identity token, an identity of the requesting entity by verifying the cryptographic digital signature of the identity token to establish a validated identity;
store, in a recorded database, a permission to access that associates a single entity with each resource of a plurality of resources;
restrict each resource of the plurality of resources to only one controlling entity at a time;
determine, for the validated identity, a permission of the requesting entity to access the resource by querying the recorded database for a current recordation of the permission to access for the resource;
grant access to the quantum-computing utility at an access-control gate based on the permission of the requesting entity;
allocate, on demand, an interchangeable one of the quantum-computing utilities that matches the request;
communicate, through a private tunnel encrypted at both ends, with the requesting entity;
record and enforce the permission to access through an internal blockchain module;
wherein the resource is one of the plurality of resources stored in a database;
